(19) United States
(12) Patent Application Publication
(10) Pub. No.: US 2025/0106771 A1
(43) Pub. Date: Mar. 27, 2025

(54) COVERAGE ENHANCEMENT

(71) Applicant: Nokia Technologies Oy, Espoo (FI)

(72) Inventors: Brajesh SONI, Bangalore (IN); Sreekanth K, Bangalore (IN); Faranaz SABOURI-SICHANI, Aalborg (DK); Jan Torst HVIID, Aalborg (DK); Rajesh BANDA, Bangalore (IN); Tanumay MANNA, Bangalore (IN)

(21) Appl. No.: 18/816,748

(22) Filed: Aug. 27, 2024

(30) Foreign Application Priority Data
Sep. 26, 2023 (IN) 202341064598

(51) Int. Cl. H04W 52/02; H04W 24/10

(52) U.S. Cl. CPC H04W 52/0235; H04W 24/10; H04W 52/0245; H04W 52/0261

(57) ABSTRACT

Example embodiments of the present disclosure relate to devices, methods, apparatuses and computer readable storage medium for coverage enhancement. In a method, a first apparatus receives, from a second apparatus, a first configuration for enabling relaying of a first wakeup signal transmitted by the second apparatus. Then, the first apparatus monitors, based on at least the first configuration, the first wakeup signal relayed via a third apparatus.

### CROSS-REFERENCE TO RELATED APPLICATION

This application claims priority from, and the benefit of, India Provisional Application No. 202341064598, filed Sep. 26, 2023, the contents of which are hereby incorporated by reference in their entirety.

### FIELDS

Various example embodiments of the present disclosure generally relate to the field of telecommunication and in particular, to methods, devices, apparatuses and computer readable storage medium for coverage enhancement.

### BACKGROUND

Devices without a continuous energy source may comprise, for example, user equipment (UEs) using small rechargeable and non-rechargeable single coin cell batteries, such as those used for vertical use cases (including sensors and actuators that are deployed extensively for monitoring, measuring, charging, and/or the like). Generally, their batteries are not rechargeable and expected to last at least few years. Additionally, this type of devices may also include wearables such as smart watches, rings, eHealth related devices, and medical monitoring devices, for which it is challenging to sustain up to 1 to 2 weeks, as required, with typical battery capacity.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a first configuration for enabling relaying of a first wakeup signal transmitted by the second apparatus; and monitor, based on at least the first configuration, the first wakeup signal relayed via a third apparatus.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a first configuration for enabling relaying of a first wakeup signal transmitted by the second apparatus; and transmit the first wakeup signal via a third apparatus.

In a third aspect of the present disclosure, there is provided a method. The method comprises: receiving, from a second apparatus, a first configuration for enabling relaying of a first wakeup signal transmitted by the second apparatus; and monitoring, based on at least the first configuration, the first wakeup signal relayed via a third apparatus.

In a fourth aspect of the present disclosure, there is provided a method. The method comprises: transmitting, to a first apparatus, a first configuration for enabling relaying of a first wakeup signal transmitted by the second apparatus; and transmitting the first wakeup signal via a third apparatus.

In a fifth aspect of the present disclosure, there is provided a first apparatus. The first apparatus comprises means for receiving, from a second apparatus, a first configuration for enabling relaying of a first wakeup signal transmitted by the second apparatus; and means for monitoring, based on at least the first configuration, the first wakeup signal relayed via a third apparatus.

In a sixth aspect of the present disclosure, there is provided a second apparatus. The second apparatus comprises means for transmitting, to a first apparatus, a first configuration for enabling relaying of a first wakeup signal transmitted by the second apparatus; and means for transmitting the first wakeup signal via a third apparatus.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A and 1B illustrate example UE operations with a low-power-wake-up receiver;

FIG. 2 illustrates an example communication environment in which example embodiments of the present disclosure can be implemented;

FIG. 3 illustrates a signaling diagram for an example communication process in accordance with some example embodiments of the present disclosure;

FIG. 4 illustrates a flowchart of an example process of SL-Wus-Paging establishment in accordance with some example embodiments of the present disclosure;

FIG. 5 illustrates a diagram of paging occasion monitoring in accordance with some example embodiments of the present disclosure;

FIG. 6 illustrates a flowchart of an example process of SL-Wus-Paging release in accordance with some example embodiments of the present disclosure;

FIG. 7 illustrates serving cell and user equipment (UE)-to-network (U2N) relay UE LP-WUS strength variation with respect to UE movement and channel condition in accordance with some example embodiments of the present disclosure;

FIG. 8 shows a flowchart of an example method implemented at the first apparatus in accordance with some example embodiments of the present disclosure;

FIG. 9 shows a flowchart of an example method implemented at the second apparatus in accordance with some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Some of the device types (for example, sensors, actuators and wearables), not only require a long battery life, but also require latency-critical services (such as sensors for fire detection and extinguishing). Therefore, techniques such as Extended Discontinuous Reception (eDRX) (allowing to extend the periodicity by which the UE wakes up to monitor for paging, which in turn reduces the average power consumption) are not applicable as eDRX may lead to unacceptable communication latency.

Low-power Wake-Up Signal (LP-WUS) may be used to enable further UE power saving for the aforementioned device types. The objectives may include identifying evaluation methodology (including the use cases) and Key Performance Indicators (KPIs) that primarily target low-power Wake Up Signal (WUS)/Wake Up Receiver (WUR) for power-sensitive, small form-factor devices including IoT use cases (such as industrial sensors and controllers) and wearables.

Moreover, the following aspects may be studied and evaluated: low-power wake-up receiver architectures, wake-up signal designs to support wake-up receivers; Layer 1 (L1) procedures and higher layer protocol changes needed to support the wake-up signals; potential UE power saving gains compared to the existing Release-15/16/17 UE power saving mechanisms and their coverage availability, as well as latency impact; and system impact, such as network power consumption, coexistence with non-low-power-WUR UEs, network coverage/capacity/resource overhead.

The usage of a separate low-power wake-up receiver at the UE may be studied and evaluated to determine how this can reduce the UE power consumption. A main radio or receiver of the UE may be in a sleep mode (or even powered off) for power saving and be activated only upon the reception of the wake-up signal from the network.

The low-power wake-up receiver may be assumed to be operated in an always ‘on’ or duty cycled manner with very low power consumption. It is expected that it may consume significantly less power compared to a NR transceiver, by designing a simple WUS signal and the use of dedicated hardware for its monitoring, which is only able to receive the WUS.

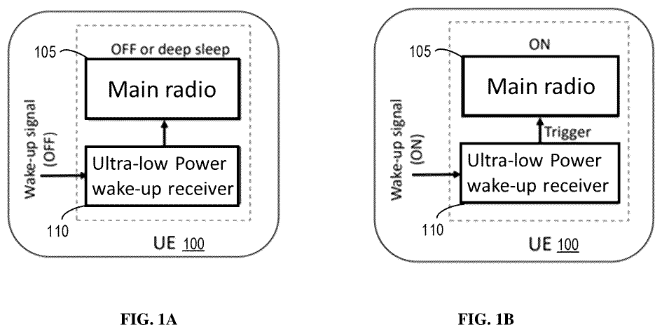

FIGS. 1A and 1B illustrate example UE operations with a low-power-wake-up receiver. In these examples, a UE 100 is configured with a main radio 105 and an ultra-low power wake-up receiver 110. As shown in FIG. 1A, if the ultra-low power wake-up receiver 110 receives no wake-up signal, the main radio 105 of the UE 110 may be in an OFF mode or a deep sleep mode. If the ultra-low power wake-up receiver 110 receives a wake-up signal, the main radio 110 of the UE 100 may be triggered to be in an ON mode.

LP-WUS may be designed to have a similar coverage as NR channel X. The NR channel X may be a physical downlink control channel (PDCCH) or a physical uplink shared channel (PUSCH), and a PUSCH with a data rate defined in the coverage system information (SI) or a PUSCH for message3 may be studied.

The WUS is agreed to be integrated within the NR bands and may be scheduled in parallel with NR data activity. Despite being transmitted from the same cell, varying environment condition may have different impacts on the legacy NR signal/data and the LP-WUS. Low-power Radio (LR) as a simple radio frequency (RF)-receiver may receive differently degraded LP-WUS signals than main radio (MR) received legacy NR signals.

Since the LR is expected to require higher signal-to-noise ratio (SNR) to decode the LP-WUS compared to the SNR required to decode a Synchronization Signal Block (SSB), an issue raises in the case that the LR may find LP-WUS undecodable at a cell edge and other shady regions of cell coverage. In this situation, the UE at the cell edge may choose to exit from an LP-WUS mode and work in a legacy NR mode. Thus, imperfect detection of the LP-WUS at the cell edge may lead to miss the LP-WUS indication or increase false wake-up.

Example embodiments of the present disclosure propose a coverage enhancement scheme. With this scheme, a first configuration for enabling relaying of a first wakeup signal transmitted by a second apparatus (for example, a gNB) is transmitted from the second apparatus to a first apparatus (for example, a UE). Then, based on at least the first configuration, the first apparatus monitors the first wakeup signal relayed via a third apparatus (for example, a relay UE). Therefore, in a case that the second apparatus transmits the first wakeup signal via the third apparatus to the first apparatus, the first apparatus may be able to receive it.

In this way, the second apparatus may be enabled to enhance its coverage (for example, LP-WUS coverage) via the third apparatus, thereby reducing miss detection of an LP-WUS and false wake up of main radio of the first apparatus. Further, the energy savings of the first apparatus may be enhanced.

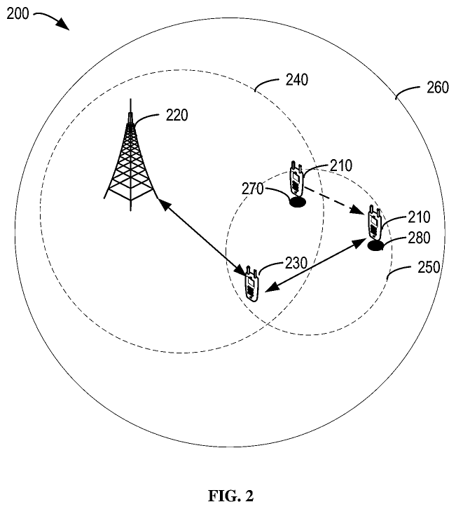

FIG. 2 illustrates an example communication environment 200 in which example embodiments of the present disclosure can be implemented.

The communication environment 200 comprises a first apparatus 210, a second apparatus 220, and a third apparatus 230. In some example embodiments, these apparatuses may operate in NR coverage 260. The first and third apparatuses 210 and 230 may operate as terminal devices (for example, UEs) which may be communicate each other directly, for example, via a PC-5 interface. The second apparatus 220 may operate as a network device, for example, a gNB, and the second apparatus 220 may serve degraded low-power (LP) wake up signal (WUS) coverage 240 (also referred to as a serving cell) within the NR coverage 260.

It is to be understood that the number and types of devices are shown in FIG. 2 for the purpose of illustration without suggesting any limitation. For example, the communication environment 200 may comprise any numbers of apparatuses.

In some example embodiments, a link from the second apparatus 220 to the first apparatus 210 or the third apparatus 230 may be referred to as a downlink (DL), and a link from the first apparatus 210 or the third apparatus 230 to the second apparatus 220 may be referred to as an uplink (UL). In DL, the second apparatus 220 is a transmitting (TX) device (or a transmitter) and the first apparatus 210 or the third apparatus 230 is a receiving (RX) device (or a receiver). In UL, the first apparatus 210 or the third apparatus 230 is a TX device (or a transmitter) and the second apparatus 220 is a RX device (or a receiver). A link between the first apparatus 210 and the third apparatus 230 may be referred to as a sidelink (SL). In SL, one of the first apparatus 210 and the third apparatus 230 is a TX device (or a transmitter), and the other of the first apparatus 210 and the third apparatus 230 is a RX device (or a receiver).

In the following, for the purpose of illustration, some example embodiments are described with the first apparatus 210 and/or the third apparatus 230 operating as terminal devices, the second apparatus 220 operating as an access network device and the third apparatus 230 operating as a core network device. However, in some example embodiments, operations described with respect to a terminal device may be implemented at a network device or other devices, and operations described with respect to a network device may be implemented at a terminal device or other devices.

The apparatuses 210, 220, and 230 can communicate with each other. Communications in the communication environment 200 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

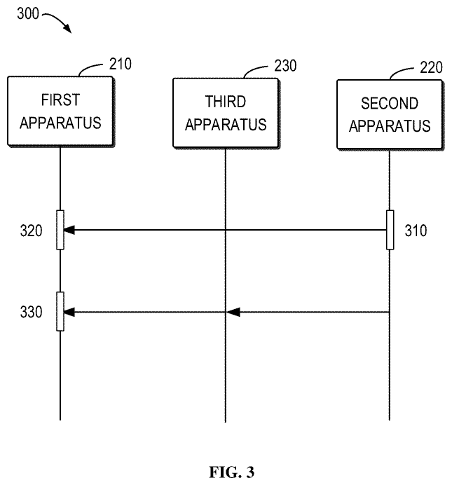

In the communication environment 200, the first apparatus 210 may be firstly located at a point 270 within the coverage 240. Then, the first apparatus 210 moves from the point 270 to a point 280 outside the coverage 240 and fall within a coverage 250 of the third apparatus 230. This may result in a degradation of received LP-WUS signal strength from the second apparatus 220. In this situation, the third apparatus 230 positioned close to the second apparatus 220 may act as a relay terminal device, for example a U2N relay UE, which can relay the LP-WUS signal from the serving cell (or the coverage 240) of the second apparatus 220 to the first apparatus 210 (which may operate as a remote terminal device) at the point 280. Then, the coverage 240 can be extended for the first apparatus 210 via the third apparatus 230. Some example implementations will be described below with reference to FIG. 3.

FIG. 3 illustrates a signaling diagram for an example communication process 300 in the communication environment 200 according to some example embodiments of the present disclosure.

As shown in FIG. 3, the second apparatus 220 may transmit (310), to the first apparatus 210, a first configuration for enabling relaying of a wakeup signal (WUS) (referred to as a first wakeup signal) transmitted by the second apparatus 220 to the first apparatus 210. In some example embodiments, the first configuration may be transmitted from the second apparatus 220 to the first apparatus 210 via at least one of broadcast signaling or dedicated signaling. For example, the second apparatus 220 may broadcast the first configuration via a system information block (SIB) such as SIB-2 (or SIB2) and SIB-22 (or SIB22) with a configuration of a WUS (or WUS config). Alternatively, or in addition, the second apparatus 220 may transmit the first configuration via dedicated signalling.

The first configuration may comprise any configuration to enabling relaying of the first wakeup signal. In some example embodiments, the first configuration may indicate a first threshold strength for a measured strength of a wakeup signal relayed via an apparatus, and/or a second threshold strength for a measured strength of a wakeup signal (referred to as a second wakeup signal) from the second apparatus 220 without relaying. The first threshold strength may be used to detect a suitable apparatus for relaying the first wakeup signal. The second threshold strength may be used to enable the relay process or service. In the embodiments where the first and third apparatuses 210 and 230, a relay process of a WUS may be referred to as an SL-Wus-Paging procedure, and the second threshold strength may be referred to as an SL-Wus-Paging threshold.

After the first apparatus 210 receives (320) the first configuration for enabling the relaying of the first wakeup signal, the first apparatus 210 may monitor (330), based on at least the first configuration, the first wakeup signal relayed via a third apparatus 230. In some example embodiments, based on the measured strength of the second wakeup signal being less than the second threshold strength, the first apparatus 210 may determine that the relaying of the first wakeup signal is enabled.

By way of example, in the case that the first apparatus 210 is monitoring the second wakeup signal from the second apparatus 220 without relaying. If the first apparatus 210 receives the first configuration indicating the second threshold strength for a measured strength of the second wakeup signal, the first apparatus 210 may compare the measured strength of the second wakeup signal with the second threshold strength. If the measured strength of the second wakeup signal is less than the second threshold strength, the first apparatus 210 may determine that the relaying of the first wakeup signal is enabled.

In some example embodiments, the measured strength of the second wakeup signal to be compared with the second threshold strength may be an average value of a plurality measured strengths of the second wakeup signal to further avoid ping pong effect. For example, the first apparatus 210 may monitor the serving cell (or the coverage 240) of the second apparatus 220 for a duration of time and then compare an average value of the measured strengths of the second wakeup signal with the second threshold strength. The duration of the time may be configured from the network or set by the first apparatus 210 itself.

In some example embodiments, other signals than the second wakeup signal may be used to enable the relay service. For example, the first apparatus 210 may determine to enable the relay procedure based on a comparison of a measured strength of a synchronization signal (SS) or a beacon signal with the second threshold strength.

In some example embodiments, based on the first configuration, the first apparatus 210 determines that the relaying of the first wakeup signal is enabled, and then the first apparatus 210 may transmit, to the second apparatus 220, a request for a configuration for the relaying of the first wakeup signal via the third apparatus 230.

The third apparatus 230 may be determined by the first apparatus 210 using a SL discovery procedure. In some example embodiments, after determining that the relaying of the first wakeup signal is enabled, the first apparatus 210 may establish, based on a discovery mode, a communication path with the third apparatus 230. Any suitable discovery mode may be used by the first apparatus 210.

In some example embodiments, preferences for a plurality of discovery modes may be provided by the network. For example, the first apparatus 210 may receive preferences for the plurality of discovery modes from the second apparatus 220 via broadcast signaling (such as a SIB) and/or dedicated signaling. In an example, in the embodiments where the first apparatus 210 and the third apparatus 230 are terminal devices, the preferences may be embedded in SL profile and priority. Based on the preferences for the plurality of discovery modes, the first apparatus 210 may select one of the discovery modes and used the selected one of the discovery mode for establishing the communication path with the third apparatus 230 for subsequent relaying.

In some example embodiments, in the case that the first configuration indicates the first threshold strength for a measured strength of the wakeup signal relayed via an apparatus, the first apparatus 210 may determine the third apparatus 230 based on the comparison of a measured strength of a signal received from the third apparatus 230 and the first threshold strength. For example, the first apparatus 210 may discovery a plurality of ambient apparatuses using the discovery procedure. The first apparatus 210 may select one of the ambient apparatuses with the measured strength greater than the first threshold strength.

In some example embodiments, after the third apparatus 230 is identified, the first apparatus 210 may transmit, to the third apparatus 230, an indication that the relaying of the first wakeup signal via the third apparatus 230 is enabled. In the case that the first apparatus 210 and the third apparatus 230 are both terminal devices, a relay service, e.g., SL-WUS-Paging may be indicated to the third apparatus 230 to indicate the U2N relay service for relaying an LP-WUS via PC5, thereby providing coverage extension of the LP-WUS for ambient devices.

In some example embodiments, the request for a configuration for the relaying of the first wakeup signal via the third apparatus 230 may be transmitted by the first apparatus 210 to the second apparatus 220 via the third apparatus 230, for example, in the communication path between the first apparatus 210 and the third apparatus 230. After the second apparatus 220 receives this request, the second apparatus 220 may determine an apparatus for relaying the first wakeup signal. For example, the second apparatus 220 may determine that the first wakeup signal is to be relayed via the third apparatus 230.

The second apparatus 220 may transmit, to the first apparatus 210, a second configuration for the relaying of the first wakeup signal via the third apparatus 230. Then the first apparatus 210 may receive the second configuration from the second apparatus 220. After that, the first apparatus 210 may monitor, based on the second configuration, the first wakeup signal relayed via the third apparatus 230. The second apparatus 220 may transmit, to the first apparatus 210, the first wakeup signal via the third apparatus 230.

In some example embodiments, the request may include a measurement report for a communication path with the third apparatus 230. In an example, the measurement report may be used by the second apparatus 220 to determine whether the third apparatus 230 is suitable for relaying. In an example, in the embodiments where the first apparatus 210 and the third apparatus 230 are both terminal devices, the first apparatus 210 may send a side link message, e.g., called SL-Wus-Paging-Configuration-Request with a measurement result of a PC5 interface with a relay providing an LP-WUS_Paging service.

If the second apparatus 220 finds that the third apparatus 230 is suitable (considering U2N relay PC-5 measurement report and possible other criteria like—U2N mobility, cell edge information), the second apparatus 220 may provide SL-Wus-Paging-Configuration via a radio resource control (RRC) message such as the rrcReconfiguration message. In this case, the third apparatus 230 used for the relaying is the third apparatus 230.

In some example embodiments, if the second apparatus 220 determines that the third apparatus 230 is unsuitable for the relaying, the second apparatus 220 may transmit, to the first apparatus 210, a request to identify another apparatus rather than the third apparatus 230 for the relaying of the first wakeup signal. For example, if the measurement result of the third apparatus 230 is not good enough or the second apparatus 220 does not find a suitable relay from a PC5 interface measurement report in the request from the first apparatus 210, the second apparatus may request the first apparatus 210 to provide other relay candidates such as ambient U2N relay UEs (offering RSC-SL-Wus-Paging) in a rrcReconfigurationRequest message. In some other example embodiments, the second apparatus 220 may suggest other relay apparatuses (for example, based on positioning).

After the first apparatus 210 receives the request for identifying another apparatus rather than the third apparatus 230 for the relaying of the first wakeup signal, if the first apparatus 210 determines that the third apparatus 230 is to be used for the relaying of the first wakeup signal, the first apparatus 210 may transmit, to the second apparatus 220, a request for a configuration for the relaying of the first wakeup signal via the third apparatus 230.

After the second apparatus 220 receives the request for the configuration for the relaying of the first wakeup signal via the third apparatus 230, the second apparatus 220 may transmit, to the first apparatus 210, the second configuration for the relaying of the first wakeup signal via the third apparatus 230. Accordingly, the first apparatus 210 may receive, from the second apparatus 220, the second configuration for the relaying of the first wakeup signal via the third apparatus 230. Then, the second apparatus 220 may transmit the first wakeup signal via the third apparatus 230.

In some example embodiments, the first apparatus 210 may monitor a second wakeup signal from the second apparatus 220 without relaying while monitoring the first wakeup signal via the third apparatus 230. An example of the second wakeup signal is an LP-WUS. In some example embodiments, the first apparatus 210 may determine that both the first and second wakeup signals are to be monitored, based on at least one of: a measured strength of the first wakeup signal, a measured strength of the second wakeup signal, a battery level of the first apparatus 210, or an instruction from the second apparatus 220.

In some example embodiments, the first apparatus 210 may receive an indication of a paging early indication (PEI) via the first wakeup signal and receive an indication of paging arrival via the second wakeup signal. For example, the second apparatus 220 may choose to send an indication of the PEI via the first wakeup signal and an indication of paging arrival via the second wakeup signal.

In some other example embodiments, the first apparatus 210 may receive an indication of the paging early indication and paging arrival via the first wakeup signal and receive an indication of the paging early indication and paging arrival via the second wakeup signal. For example, the second apparatus 220 may choose to send an indication of PEI and paging arrival via both the first and second wakeup signals.

In some example embodiments, the first apparatus 210 may cease the monitoring of the first wakeup signal based on at least one condition being met. In some example embodiments, the at least one condition may comprise a condition that the second wakeup signal is decoded properly. For example, if the first apparatus 210 may decode the second wakeup signal properly without ambiguity, the first apparatus 210 may determine that the monitoring of the first wakeup signal is to be ceased.

Alternatively, or in addition, the at least one condition may comprise a condition that a measured strength of the second wakeup signal exceeds a third threshold strength. The third threshold strength to cease the relaying of the wakeup signal may be equal to or higher than the second threshold strength for a measured strength of the second wakeup signal to enable the relaying.

In some example embodiments, in order to cease the monitoring of the first wakeup signal, the first apparatus 210 may transmit, to the second apparatus 220, a request to cease the monitoring of the first wakeup signal if a measured strength of the second wakeup signal exceeding a threshold strength. For example, if the first apparatus 210 determines that a measured strength of LP-WUS (as an example of the second wakeup signal) is greater than the third threshold strength, the first apparatus 210 a request to release the SL-Wus-Paging procedure, e.g., an SL-Wus-Paging-release request. In an example, the first apparatus 210 may send a RRC reconfiguration message such as rrcReconfigurationRequest with an SL-Wus-Paging-release request.

In some example embodiments, to further avoid ping pong effect, the first apparatus 210 may compare a strength of the second wakeup signal measured for a duration of time with the third threshold strength. If an average value of the measured strength for a duration of time exceeds the third threshold strength, the first apparatus 210 may determine to cease the monitoring of the first wakeup signal. The duration of the time may be configured from the network or set by the first apparatus 210 itself.

In some example embodiments, alternatively, or in addition, other signals such as a synchronization signal or a beacon signal may be used by the first apparatus 210 to determine whether to cease the monitoring of the first wakeup signal. For example, the first apparatus 210 may determine to release the SL-Wus-Paging procedure based on a comparison of a measured strength of a synchronization signal or a beacon signal with the third threshold strength.

In some example embodiments, the request to cease the monitoring of the first wakeup signal from the first apparatus 210 may include the latest measurement report. After the second apparatus 220 receives this request from the first apparatus 210, the second apparatus 220 may transmit, to the first apparatus 210, an indication that the monitoring of the first wakeup signal is to be ceased, or an indication that the monitoring of the first wakeup signal is to be continued.

In some example embodiments, if the first apparatus 210 receives, from the second device 220, an indication that the monitoring of the first wakeup signal is to be ceased, the first apparatus 210 may cease the monitoring of the first wakeup signal. In some example embodiments, if the first apparatus 210 receives, from the second device 220, an indication that the monitoring of the first wakeup signal is to be continued, the first apparatus 210 may continue the monitoring of the first wakeup signal.

In some example embodiments, if the measured strengths of both the first and second wakeup signals are lower, the second apparatus 220 may cause the first apparatus 210 to hand over to a new cell. For example, the second apparatus 220 may receive, from the first apparatus 210, a measurement report including a measured strength of the second wakeup signal transmitted by the second apparatus without relaying and the measured strength of the first wakeup signal relayed via the third apparatus 230. Based on the measured strength of the second wakeup signal being less than the second threshold strength and the measured strength of the first wakeup signal being less than the first threshold strength, the second apparatus 220 may cause handover of the first apparatus 110 from a current cell to a new cell which may has a better strength of LP-WUS and NR signal or better normal NR operation.

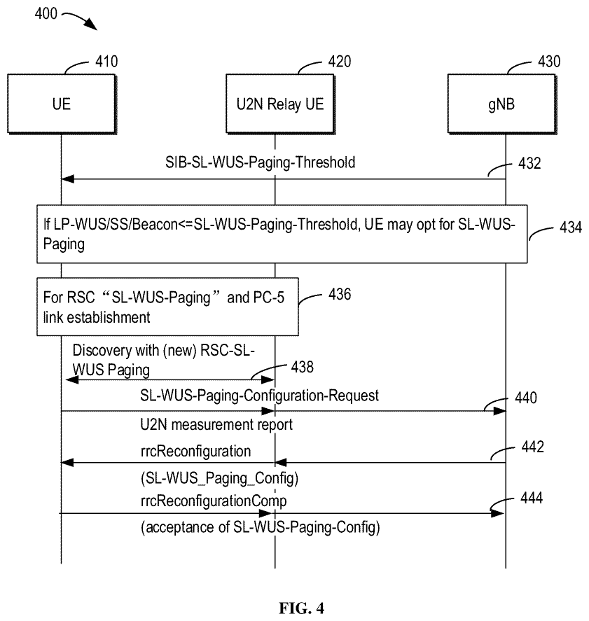

Some example coverage enhancement processes will be described in detail below with reference to FIGS. 4 to 7. In these examples, a UE 410 (also called a remote UE) operates as an example implementation of the first apparatus 210 in FIG. 2, a U2N relay UE 420 (also called a relay UE) operates as an example implementation of the third apparatus 230 in FIG. 2. A gNB 430 operates as example implementations of the second apparatus 220. The first threshold strength may be used to enable the SL-WUS-Paging feature or procedure and may be referred to as SL-WUS-Paging-Threshold. FIG. 4 illustrates a flowchart of an example process 400 of SL-Wus-Paging establishment in accordance with some example embodiments of the present disclosure.

In some example embodiments, support of the SL-Wus-Paging feature and usage of SL-WUS-Paging-Threshold may be indicated by the gNB 430. In one example case, the gNB 430, which supports the SL-WU-Paging feature, the gNB 430 may broadcasts (432) SL-WUS-Paging-Threshold via SIB (for example, SIB2 or SIB22). In another example case, the gNB 430 may assign SL-WUS-Paging-Threshold specific to the UE 410 via dedicated signaling (for example, rrcREconfiguration). The gNB 430 may use paging history, probability, service severity or the like of the UE 410 to configure the specific SL-WUS-Paging-Threshold to the UE 410.

The UE 410 may utilize this threshold to compare with a strength of an LP-WUS, SS, or beacon signal, also called an LP-WUS, SS, or beacon strength. At 434, if measured signal strength falls below SL-WUS-Paging-Threshold, the UE 410 may trigger a SL-WUS-Paging procedure to establish SL-WUS-Paging monitoring.

In some example embodiments, at 436, the UE 410 may indicate a relay service code (RSC)-“SL-Wus-Paging” to the U2N relay UE 420 to indicate the interest and support of SL-Wus-Paging via the U2N relay PC-5 interface and perform PC-5 link establishment. Any discovery model (e.g., Discovery Model A and Model B) can be used for discovery and subsequently establishment of PC5 interface for SL-Wus-Paging. In one example case, the remote UE 410 may use either discovery model A or B to establish PC5 interface for SL-Wus-Paging. In another example case, the discovery model B with restricted discovery may be employed to enhance the security aspect.

In some example embodiments, preferences for the discovery model A or B may be provided via the gNB 430 (for example, through SIB/dedicated signaling), embedded in SL profile and priority from which the UE 410 may resolve the preferences in any suitable way.

In some example embodiments, at 438, a discovery procedure is established between the UE 410 and the U2N relay UE 420 for enabling LP-WUS or paging relaying via the U2N relay UE 420. The UE 410 may use the aforementioned condition to trigger or request the SL-Wus-Paging configuration.

As shown in FIG. 4, the UE 410 may send (440) a new side link message, for example, SL-Wus-Paging-Configuration-Request with a measurement result of PC5 interface with the U2N relay UE 420 providing LP-Wus_Paging service. If the gNB 430 (or the network) finds the U2N relay UE 420 is suitable (considering the U2N relay PC-5 measurement report and possible other criteria like—U2N mobility, cell edge information), the gNB 430 may provide (442) SL-Wus-Paging-Configuration via rrcReconfiguration message. The UE 410 may transmit (444) rrcReconfigurationComp to indicate acceptance of SL-WUS-Paging-Config.

In another example case, if the gNB 430 (or the network) does not find a suitable relay in the PC5 interface measurement report provided by the UE 410, the gNB 430 (or the network) may suggest other relay UEs (based on positioning) or ask the UE 410 to provide other ambient U2N relay UEs (offering RSC-SL-Wus-Paging) in rrcReconfigurationRequest message.

In another use case, the UE 410 may choose to monitor both of the LP-WUS, for example, including Legacy LP-WUS and SL-Wus-Paging. The UE 410 may monitor both of the WUS for a paging indication based on LP-Wus strength, SL-Wus-Paging (PC-5) strength, UE battery level, or based in instructions from the network (NW). In an example, after the establishment of U2N path for the SL-WUS-Paging service, the UE 410 may monitor both LP-WUS and SL-WUS occasions, also called LP-WUS and SL-WUS paging occasions. If the UE 410 may detect or decode LP-WUS properly without any ambiguity, the UE 410 may choose to skip the SL-WUS-Paging monitoring for the occasion or may still choose to monitor both.

In another example, the gNB 430 may choose to send an indication of PEI via SL-Wus-Paging and an indication of paging arrival via LP-WUS. In the other example, the gNB 430 may choose to send an indication of PEI and paging arrival via both SL-Wus-Paging and LP-WUS Paging.

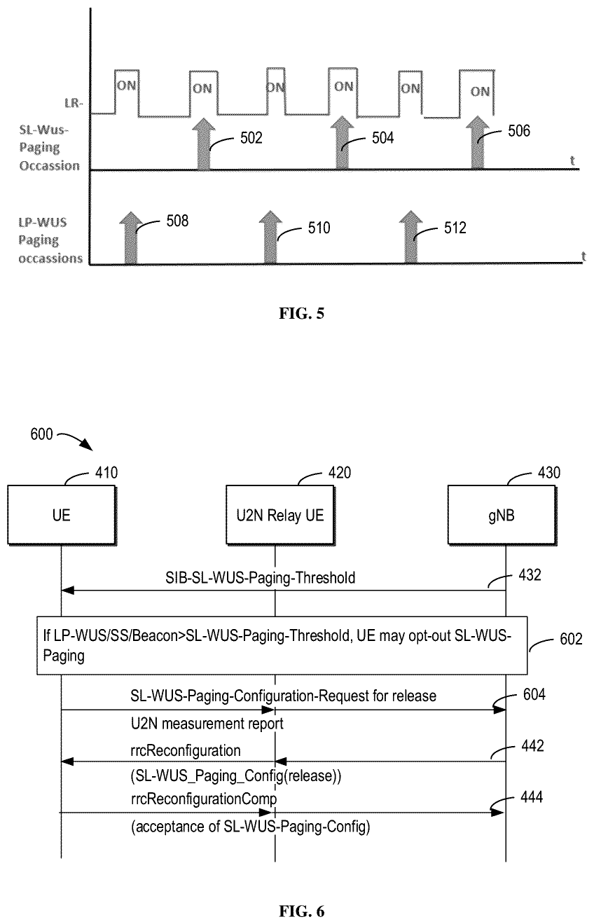

FIG. 5 illustrates a diagram of paging occasion monitoring according to some example embodiments of the present disclosure.

As shown in FIG. 5, the UE 410 monitors SL-Wus-Paging occasions 502, 504 and 506 and LP-WUS-Paging occasions 508, 510 and 512. Low power radio (LR) for the UE 410 are triggered with the SL-Wus-Paging occasions and LP-WUS-Paging occasions.

FIG. 6 illustrates a flowchart of an example process 600 of SL-Wus-Paging release in accordance with some example embodiments of the present disclosure.

In the process 600, the UE 410 opts out the SL-Wus-Paging monitoring. The UE 410 may regularly monitor LP-WUS, SS, or beacon signal and if it finds SL-WUS/SS/Beacon strength>SL-Wus-Paging-Threshold, the UE 410 may send (602) an SL-Wus-Paging-Request for release (also called SL-Wus-Paging-release request) message with latest measurement report. The gNB 430 may send (604) rrcReconfiguration with an SL-Wus-Paging-release response to release the relay UE 420 or resources to monitor SL-Wus_paging. In another example case, based on certain criterion, the gNB 430 may still ask the UE 410 to continue the SL-Wus-Paging monitoring.

It is to be understood that the names of the messages and information elements (IEs) such as SL-Wus-Paging-release, SL-Wus-Paging-Configuration, and SL-WUS-Paging-Threshold are only examples, but not limited. Any name may be used or defined for the WUS or paging relaying depending on the 3GPP standardization.

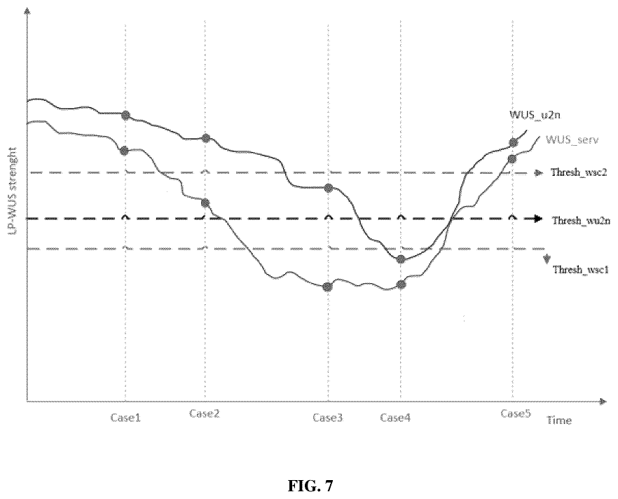

FIG. 7 illustrates a diagram of serving cell and U2N relay UE LP-WUS strength variation with respect to UE movement and channel condition according to some example embodiments of the present disclosure.

In different instances of LP-WUS strengths of the serving cell and the U2N relay UE are shown in FIG. 7, WUS_serv indicates the measured value of LP-WUS of the serving cell and WUS_u2n indicates the measured value of an LP-WUS strength of the U2N relay UE. Thresh_wsc1, Thresh_wsc2 and Thresh_wu2n are different threshold values proposed to categorise the measured LP-WUS signal into different measurement instances. The value of Thresh_wsc1 can be selected based on the low power receiver sensitivity.

Based on the reported LP-WUS signal strength, following actions are proposed as described in Table 1.

TABLE 1

| Instances | Serving cell LP-WUS | U2N LP-WUS | Proposed actions |
|---|---|---|---|
| Case1 | WS_serv > | Irrespective of | No action required. |
| | Thresh_wsc2 | WS_u2n | Normal LP-WUS operation |
| Case2 | WS_serv < | WS_u2n > | UE shall monitor the serving cell |
| | Thresh_wsc2 & | Thresh_wu2n | WUS strength (WUS_serv) for a |
| | WS_serv > | | defined duration of time and compare |
| | Thresh_wsc1 | | the average value with Thresh_wsc2 |
| | | | to avoid ping pong effect. |
| | | | If the average WUS_serv value from |
| | | | above step is below Thresh_wsc2 and |
| | | | WS_u2n > Thresh_wu2n, then UE |
| | | | shall initiate the procedure to enable |
| | | | LP-WUS/Paging relaying via U2N as |
| | | | described in Embodiment 3. |
| Case3 | WS_serv < | WS_u2n > | UE shall monitor the serving cell |
| | Thresh_wsc1 | Thresh_wu2n | WUS strength (WUS_serv) for a |
| | | | defined duration of time and compare |
| | | | the average value with Thresh_wsc1 |
| | | | to avoid ping pong effect. |
| | | | If the average WUS_serv value from |
| | | | above step is below Thresh_wsc2 and |
| | | | WS_u2n > Thresh_wu2n, then UE |
| | | | shall initiate the procedure to enable |
| | | | LP-WUS/Paging relaying via U2N as |
| | | | described in Embodiment 3. |
| | | | UE may stop monitoring the serving |
| | | | cell LP-WUS occasions. |
| Case4 | WS_serv < | WS_u2n < | Network may consider hand over to a cell |
| | Thresh_wsc1 | Thresh_wu2n | with better LP-WUS and NR |
| | | | signal/Normal NR operation. |
| Case5 | WS_serv > | WS_u2n > | If the UE is monitoring both LP-WUS |
| | Thresh_wsc2 | Thresh_wu2n | paging and SL-WUS-Paging as |
| | | | described in Embodiment 3 and the |
| | | | average WUS_serv value is above |
| | | | Thresh_wsc2, then UE may choose to |
| | | | release the U2N relay UE connection |
| | | | as detailed in Embodiment 4. |

### Example Methods

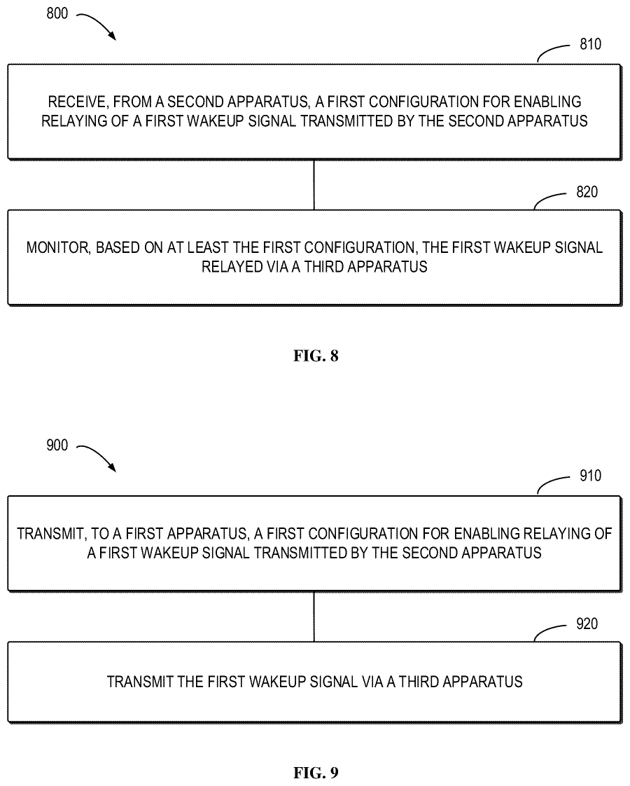

FIG. 8 shows a flowchart of an example method 800 implemented at the first apparatus 210 in accordance with some example embodiments of the present disclosure. For the purpose of discussion, the method 800 will be described from the perspective of the first apparatus 210 in FIG. 2.

At block 810, the first apparatus 210 receives, from a second apparatus, a first configuration for enabling relaying of a first wakeup signal transmitted by the second apparatus.

At block 820, the first apparatus 210 monitors, based on at least the first configuration, the first wakeup signal relayed via a third apparatus.

In some example embodiments, the first configuration indicates at least one of: a first threshold strength for a measured strength of the first wakeup signal relayed via the third apparatus, or a second threshold strength for a measured strength of a second wakeup signal transmitted by the second apparatus without relaying.

In some example embodiments, based on the measured strength of the second wakeup signal being less than the second threshold strength for a duration of time, the first apparatus 210 determines that the relaying of the first wakeup signal is enabled.

In some example embodiments, in accordance with determining, based on the first configuration, that the relaying of the first wakeup signal is enabled, the first apparatus 210 transmits, to the second apparatus, a request for a configuration for the relaying of the first wakeup signal via a third apparatus. Then, the first apparatus 210 receives, from the second apparatus, a second configuration for the relaying of the first wakeup signal via the third apparatus; and monitors, based on the second configuration, the first wakeup signal relayed via the third apparatus.

In some example embodiments, the request for the configuration for the relaying of the first wakeup signal via the third apparatus is transmitted to the second apparatus via the third apparatus.

In some example embodiments, the request includes a measurement report for a communication path with the third apparatus.

In some example embodiments, in accordance with determining, based on the first configuration, that the relaying of the first wakeup signal is enabled, the first apparatus 210 establishes, based on a discovery mode, the communication path with the third apparatus. The first apparatus 210 transmit, to the second apparatus, the request for the configuration for the relaying of the first wakeup signal via the communication path with the third apparatus.

In some example embodiments, the first apparatus 210 receives, from the second apparatus, preferences for a plurality of discovery modes; and selects the discovery mode from the plurality of discovery modes based on the preferences.

In some example embodiments, the first apparatus 210 transmits, to the third apparatus, an indication that the relaying of the first wakeup signal via the third apparatus is enabled.

In some example embodiments, the first apparatus 210 monitors a second wakeup signal from the second apparatus without relaying.

In some example embodiments, the first apparatus 210 determines that both the first and second wakeup signals are to be monitored, based on at least one of: a measured strength of the first wakeup signal, a measured strength of the second wakeup signal, a battery level of the first apparatus, or an instruction from the second apparatus.

In some example embodiments, the first apparatus 210 receives an indication of a paging early indication via the first wakeup signal, and receives an indication of paging arrival via the second wakeup signal.

In some example embodiments, the first apparatus 210 receives an indication of a paging early indication and paging arrival via the first wakeup signal and receives an indication of paging arrival via the second wakeup signal.

In some example embodiments, the first apparatus 210 ceases the monitoring of the first wakeup signal based on at least one condition being met, the at least one condition comprising at least one of: a condition that the second wakeup signal is decoded properly, or a condition that a measured strength of the second wakeup signal exceeds a third threshold strength.

In some example embodiments, the first apparatus 210, based on a measured strength of the second wakeup signal exceeding a third threshold strength for a duration of time, transmits, to the second apparatus, a request to cease the monitoring of the first wakeup signal.

In some example embodiments, the first apparatus 210, in response to receiving, from the second device, an indication that the monitoring of the first wakeup signal is to be ceased, ceases the monitoring of the first wakeup signal.

In some example embodiments, the first apparatus 210, in response to receiving, from the second device, an indication that the monitoring of the first wakeup signal is to be continued, continues the monitoring of the first wakeup signal.

In some example embodiments, the first configuration is received via at least one of broadcast signaling or dedicated signaling.

In some example embodiments, the first apparatus comprises a remote terminal device, the second apparatus comprises a network device, and the third apparatus comprises a relay terminal device.

FIG. 9 shows a flowchart of an example method 900 implemented at the second apparatus 220 in accordance with some example embodiments of the present disclosure. For the purpose of discussion, the method 900 will be described from the perspective of the second apparatus 220 in FIG. 2.

At block 910, the second apparatus 220 transmits, to a first apparatus, a first configuration for enabling relaying of a first wakeup signal transmitted by the second apparatus.

At block 920, the second apparatus 220 transmits the first wakeup signal via a third apparatus.

In some example embodiments, the first configuration indicates at least one of: a first threshold strength for a measured strength of the first wakeup signal relayed via the third apparatus, or a second threshold strength for a measured strength of a second wakeup signal transmitted by the second apparatus without relaying.

In some example embodiments, the second apparatus 220 receives, from the second apparatus, a request for a configuration for the relaying of the first wakeup signal via a third apparatus; transmits, to the first apparatus, a second configuration for the relaying of the first wakeup signal via the third apparatus; and transmits, to the first apparatus, the first wakeup signal via the third apparatus.

In some example embodiments, the request for the configuration for the relaying of the first wakeup signal via the third apparatus is received from the first apparatus via the third apparatus.

In some example embodiments, the request includes a measurement report for a communication path with the third apparatus.

In some example embodiments, the second apparatus 220 transmits, to the first apparatus, preferences for a plurality of discovery modes for establishment of the communication path between the first apparatus and the third apparatus.

In some example embodiments, the second apparatus 220 transmits a second wakeup signal to the first apparatus without relaying.

In some example embodiments, the second apparatus 220 transmits an indication of a paging early indication via the first wakeup signal, and transmits an indication of paging arrival via the second wakeup signal.

In some example embodiments, the second apparatus 220 transmits an indication of a paging early indication and paging arrival via the first wakeup signal; and transmits an indication of a paging early indication and paging arrival via the second wakeup signal.

In some example embodiments, the second apparatus 220 receives, from the first apparatus, a request to cease the monitoring of the first wakeup signal; and transmits, to the first apparatus, at least one of: an indication that the monitoring of the first wakeup signal is to be ceased, or an indication that the monitoring of the first wakeup signal is to be continued.

In some example embodiments, the first configuration is transmitted via at least one of broadcast signaling or dedicated signaling.

In some example embodiments, the second apparatus 220 receives, from the first apparatus, a measurement report including a measured strength of a second wakeup signal transmitted by the second apparatus without relaying and a measured strength of the first wakeup signal relayed via the third apparatus. Based on the measured strength of the second wakeup signal being less than a second threshold strength and the measured strength of the first wakeup signal being less than a first threshold strength, the second apparatus 220 causes handover of the first apparatus from a current cell to a new cell.

In some example embodiments, the first apparatus comprises a remote terminal device, the second apparatus comprises a network device, and the third apparatus comprises a relay terminal device.

### Example Apparatus, Device and Medium

In some example embodiments, a first apparatus capable of performing any of the method 800 (for example, the first apparatus 210 in FIG. 2 may comprise means for performing the respective operations of the method 800. The means may be implemented in any suitable form. For example, the means may be implemented in a circuitry or software module. The first apparatus may be implemented as or included in the first apparatus 210 in FIG. 2.

In some example embodiments, the first apparatus comprises means for receiving, from a second apparatus, a first configuration for enabling relaying of a first wakeup signal transmitted by the second apparatus; and means for monitoring, based on at least the first configuration, the first wakeup signal relayed via a third apparatus.

In some example embodiments, the first configuration indicates at least one of: a first threshold strength for a measured strength of the first wakeup signal relayed via the third apparatus, or a second threshold strength for a measured strength of a second wakeup signal transmitted by the second apparatus without relaying.

In some example embodiments, the first apparatus comprises means for based on the measured strength of the second wakeup signal being less than the second threshold strength for a duration of time, determining that the relaying of the first wakeup signal is enabled.

In some example embodiments, the first apparatus comprises means for, in accordance with determining, based on the first configuration, that the relaying of the first wakeup signal is enabled, transmitting, to the second apparatus, a request for a configuration for the relaying of the first wakeup signal via a third apparatus; means for receiving, from the second apparatus, a second configuration for the relaying of the first wakeup signal via the third apparatus; and means for monitoring, based on the second configuration, the first wakeup signal relayed via the third apparatus.

In some example embodiments, the request for the configuration for the relaying of the first wakeup signal via the third apparatus is transmitted to the second apparatus via the third apparatus.

In some example embodiments, the request includes a measurement report for a communication path with the third apparatus.

In some example embodiments, the first apparatus comprises means for in accordance with determining, based on the first configuration, that the relaying of the first wakeup signal is enabled, establishing, based on a discovery mode, the communication path with the third apparatus; and means for transmitting, to the second apparatus, the request for the configuration for the relaying of the first wakeup signal via the communication path with the third apparatus.

In some example embodiments, the first apparatus comprises means for receiving, from the second apparatus, preferences for a plurality of discovery modes; and means for selecting the discovery mode from the plurality of discovery modes based on the preferences.

In some example embodiments, the first apparatus comprises means for transmitting, to the third apparatus, an indication that the relaying of the first wakeup signal via the third apparatus is enabled.

In some example embodiments, the first apparatus comprises means for monitoring a second wakeup signal from the second apparatus without relaying.

In some example embodiments, the first apparatus comprises means for determining that both the first and second wakeup signals are to be monitored, based on at least one of: a measured strength of the first wakeup signal, a measured strength of the second wakeup signal, a battery level of the first apparatus, or an instruction from the second apparatus.

In some example embodiments, the first apparatus comprises means for receiving an indication of a paging early indication via the first wakeup signal, and means for receiving an indication of paging arrival via the second wakeup signal.

In some example embodiments, the first apparatus comprises means for receiving an indication of a paging early indication and paging arrival via the first wakeup signal and means for receiving an indication of a paging early indication and paging arrival via the second wakeup signal.

In some example embodiments, the first apparatus comprises means for ceasing the monitoring of the first wakeup signal based on at least one condition being met, the at least one condition comprising at least one of: a condition that the second wakeup signal is decoded properly, or a condition that a measured strength of the second wakeup signal exceeds a third threshold strength.

In some example embodiments, the first apparatus comprises means for, based on a measured strength of the second wakeup signal exceeding a third threshold strength for a duration of time, transmitting, to the second apparatus, a request to cease the monitoring of the first wakeup signal.

In some example embodiments, the first apparatus comprises means for, in response to receiving, from the second device, an indication that the monitoring of the first wakeup signal is to be ceased, ceasing the monitoring of the first wakeup signal.

In some example embodiments, the first apparatus comprises means for, in response to receiving, from the second device, an indication that the monitoring of the first wakeup signal is to be continued, continuing the monitoring of the first wakeup signal.

In some example embodiments, the first configuration is received via at least one of broadcast signaling or dedicated signaling.

In some example embodiments, the first apparatus comprises a remote terminal device, the second apparatus comprises a network device, and the third apparatus comprises a relay terminal device.

In some example embodiments, a second apparatus capable of performing any of the method 900 (for example, the second apparatus 220 in FIG. 2 may comprise means for performing the respective operations of the method 900. The means may be implemented in any suitable form. For example, the means may be implemented in a circuitry or software module. The second apparatus may be implemented as or included in the second apparatus 220 in FIG. 2.

In some example embodiments, the second apparatus comprises means for transmitting, to a first apparatus, a first configuration for enabling relaying of a first wakeup signal transmitted by the second apparatus; and means for transmitting the first wakeup signal via a third apparatus.

In some example embodiments, the first configuration indicates at least one of: a first threshold strength for a measured strength of the first wakeup signal relayed via the third apparatus, or a second threshold strength for a measured strength of a second wakeup signal transmitted by the second apparatus without relaying.

In some example embodiments, the second apparatus comprises means for receiving, from the second apparatus, a request for a configuration for the relaying of the first wakeup signal via a third apparatus; means for transmitting, to the first apparatus, a second configuration for the relaying of the first wakeup signal via the third apparatus; and means for transmitting, to the first apparatus, the first wakeup signal via the third apparatus.

In some example embodiments, the request for the configuration for the relaying of the first wakeup signal via the third apparatus is received from the first apparatus via the third apparatus.

In some example embodiments, the request includes a measurement report for a communication path with the third apparatus.

In some example embodiments, the second apparatus comprises means for transmitting, to the first apparatus, preferences for a plurality of discovery modes for establishment of the communication path between the first apparatus and the third apparatus.

In some example embodiments, the second apparatus comprises means for transmitting a second wakeup signal to the first apparatus without relaying.

In some example embodiments, the second apparatus comprises means for transmitting an indication of a paging early indication via the first wakeup signal, and means for transmitting an indication of paging arrival via the second wakeup signal.

In some example embodiments, the second apparatus comprises means for transmitting an indication of a paging early indication and paging arrival via the first wakeup signal; and means for transmitting an indication of a paging early indication and paging arrival via the second wakeup signal.

In some example embodiments, the second apparatus comprises means for receiving, from the first apparatus, a request to cease the monitoring of the first wakeup signal; and means for transmitting, to the first apparatus, at least one of: an indication that the monitoring of the first wakeup signal is to be ceased, or an indication that the monitoring of the first wakeup signal is to be continued.

In some example embodiments, the first configuration is transmitted via at least one of broadcast signaling or dedicated signaling.

In some example embodiments, the second apparatus comprises means for receiving, from the first apparatus, a measurement report including a measured strength of a second wakeup signal transmitted by the second apparatus without relaying and a measured strength of the first wakeup signal relayed via the third apparatus; and means for based on the measured strength of the second wakeup signal being less than a second threshold strength and the measured strength of the first wakeup signal being less than a first threshold strength, causing handover of the first apparatus from a current cell to a new cell.

In some example embodiments, the first apparatus comprises a remote terminal device, the second apparatus comprises a network device, and the third apparatus comprises a relay terminal device.

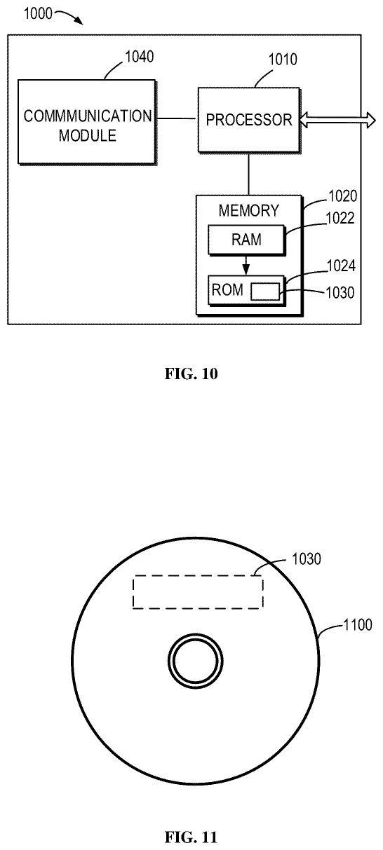

FIG. 10 is a simplified block diagram of a device 1000 that is suitable for implementing example embodiments of the present disclosure. The device 1000 may be provided to implement a communication device, for example, the first apparatus 210, the second apparatus 220 or the third apparatus 230 as shown in FIG. 2. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a first configuration for enabling relaying of a first wakeup signal transmitted by the second apparatus; and
monitor, based on at least the first configuration, the first wakeup signal relayed via a third apparatus.

2. The first apparatus of claim 1, wherein the first configuration indicates at least one of:
a first threshold strength for a measured strength of the first wakeup signal relayed via the third apparatus, or
a second threshold strength for a measured strength of a second wakeup signal transmitted by the second apparatus without relaying.

3. The first apparatus of claim 2, wherein the at least one memory and the at least one processor cause the first apparatus to:
based on the measured strength of the second wakeup signal being less than the second threshold strength for a duration of time, determine that the relaying of the first wakeup signal is enabled.

4. The first apparatus of claim 1, wherein the at least one memory and the at least one processor cause the first apparatus to:
in accordance with determining, based on the first configuration, that the relaying of the first wakeup signal is enabled, transmit, to the second apparatus, a request for a configuration for the relaying of the first wakeup signal via the third apparatus;
receive, from the second apparatus, a second configuration for the relaying of the first wakeup signal via the third apparatus; and
monitor, based on the second configuration, the first wakeup signal relayed via the third apparatus.

5. The first apparatus of claim 4,
wherein the request for the configuration for the relaying of the first wakeup signal via the third apparatus is transmitted to the second apparatus via the third apparatus; and
wherein the request includes a measurement report for a communication path with the third apparatus.

6. The first apparatus of claim 5, wherein the at least one memory and the at least one processor cause the first apparatus to:
in accordance with determining, based on the first configuration, that the relaying of the first wakeup signal is enabled, establish, based on a discovery mode, the communication path with the third apparatus; and
transmit, to the second apparatus, the request for the configuration for the relaying of the first wakeup signal via the communication path with the third apparatus.

7. The first apparatus of claim 6, wherein the at least one memory and the at least one processor further cause the first apparatus to:
receive, from the second apparatus, preferences for a plurality of discovery modes; and
select the discovery mode from the plurality of discovery modes based on the preferences.

8. The first apparatus of claim 4, wherein the at least one memory and the at least one processor further cause the first apparatus to:
transmit, to the third apparatus, an indication that the relaying of the first wakeup signal via the third apparatus is enabled.

9. The first apparatus of claim 1, wherein the at least one memory and the at least one processor further cause the first apparatus to:
monitor a second wakeup signal from the second apparatus without relaying.

10. The first apparatus of claim 9, wherein the at least one memory and the at least one processor cause the first apparatus to:
determine that both the first and second wakeup signals are to be monitored, based on at least one of:
a measured strength of the first wakeup signal,
a measured strength of the second wakeup signal,
a battery level of the first apparatus, or
an instruction from the second apparatus.

11. The first apparatus of claim 9, wherein the at least one memory and the at least one processor cause the first apparatus to:
receive an indication of a paging early indication via the first wakeup signal and
receive an indication of paging arrival via the second wakeup signal; or
receive an indication of a paging early indication and paging arrival via the first wakeup signal and receive the indication of the paging early indication and the paging arrival via the first wakeup signal via the second wakeup signal.

12. The first apparatus of claim 9, wherein the at least one memory and the at least one processor further cause the first apparatus to:
cease the monitoring of the first wakeup signal based on at least one condition being met, the at least one condition comprising at least one of:
a condition that the second wakeup signal is decoded properly, or
a condition that a measured strength of the second wakeup signal exceeds a third threshold strength.

13. The first apparatus of claim 9, wherein the at least one memory and the at least one processor further cause the first apparatus to:
based on a measured strength of the second wakeup signal exceeding a third threshold strength for a duration of time, transmit, to the second apparatus, a request to cease the monitoring of the first wakeup signal; and one of:
in response to receiving, from the second device, an indication that the monitoring of the first wakeup signal is to be ceased, cease the monitoring of the first wakeup signal; or
in response to receiving, from the second device, an indication that the monitoring of the first wakeup signal is to be continued, continue the monitoring of the first wakeup signal.

14. A second apparatus comprising:
at least one processor; and
at least one memory storing instructions that, when executed by the at least one processor, cause the second apparatus at least to:
transmit, to a first apparatus, a first configuration for enabling relaying of a first wakeup signal transmitted by the second apparatus; and
transmit the first wakeup signal via a third apparatus.

15. The second apparatus of claim 14, wherein the first configuration indicates at least one of:
a first threshold strength for a measured strength of the first wakeup signal relayed via the third apparatus, or
a second threshold strength for a measured strength of a second wakeup signal transmitted by the second apparatus without relaying.

16. The second apparatus of claim 14, wherein the at least one memory and the at least one processor cause the second apparatus to:
receive, from the first apparatus, a request for a configuration for the relaying of the first wakeup signal via the third apparatus;
transmit, to the first apparatus, a second configuration for the relaying of the first wakeup signal via the third apparatus; and
transmit, to the first apparatus, the first wakeup signal via the third apparatus.

17. The second apparatus of claim 16,
wherein the request for the configuration for the relaying of the first wakeup signal via the third apparatus is received from the first apparatus via the third apparatus; and/or
wherein the at least one memory and the at least one processor further cause the second apparatus to:
transmit, to the first apparatus, preferences for a plurality of discovery modes for establishment of the communication path between the first apparatus and the third apparatus.

18. The second apparatus of claim 14, wherein the at least one memory and the at least one processor further cause the second apparatus to:
transmit a second wakeup signal to the first apparatus without relaying; and one of:
transmit an indication of a paging early indication via the first wakeup signal and transmit an indication of paging arrival via the second wakeup signal; or
transmit an indication of a paging early indication and paging arrival via the first wakeup signal and transmit the indication of the paging early indication and the paging arrival via the second wakeup signal.

19. The second apparatus of claim 14, wherein the at least one memory and the at least one processor further cause the second apparatus to:
receive, from the first apparatus, a request to cease the monitoring of the first wakeup signal; and
transmit, to the first apparatus, at least one of:
an indication that the monitoring of the first wakeup signal is to be ceased, or
an indication that the monitoring of the first wakeup signal is to be continued.

20. The second apparatus of claim 14, wherein the at least one memory and the at least one processor further cause the second apparatus to:
receive, from the first apparatus, a measurement report including a measured strength of a second wakeup signal transmitted by the second apparatus without relaying and a measured strength of the first wakeup signal relayed via the third apparatus; and
based on the measured strength of the second wakeup signal being less than a second threshold strength and the measured strength of the first wakeup signal being less than a first threshold strength, cause handover of the first apparatus from a current cell to a new cell.
